(19) United States
(12) Patent Application Publication
(10) Pub. No.: US 2022/0130148 A1
(43) Pub. Date: Apr. 28, 2022

(54) System and Method for Identifying Outfit on a Person

(71) Applicant: OOO ITV Group, Moscow (RU)

(72) Inventors: Nikita Igorevich Biryukov, Zhigulevsk (RU); Egor Yurevich Lvov, Moscow (RU)

(21) Appl. No.: 17/482,093

(22) Filed: Sep. 22, 2021

(30) Foreign Application Priority Data
Oct. 23, 2020 (RU) 2020134859

(51) Int. Cl. G06V 20/52; G06T 7/11

(52) U.S. Cl. CPC G06V 20/52; G06T 7/11; G06T 2207/30196; G06T 2207/20081; G06T 2207/20132; G06T 2207/20084

(57) ABSTRACT

The present invention relates to the use of artificial neural networks in computer vision, and more specifically to systems and methods for processing video data received from video cameras for automatic identification of items of outfit on a person. The system for identifying outfit on a person, contain memory, image capture device, data processing device, a video acquisition module, an image analysis module, a segmentation module, an identification module, and an output module. The identification module additionally divides the results of identification into categories of the state of items of equipment, for each of which, upon passing one or several artificial neural networks, its own vector of the probability value is displayed. Achieved increased accuracy of identifying items of equipment on a person by using several artificial neural networks

### RELATED APPLICATIONS

This application claims priority to Russian Patent Application RU 2020134859, filed Oct. 23, 2020, which is incorporated herein by reference in its entirety.

### FIELD OF THE INVENTION

The present invention relates to the use of artificial neural networks in computer vision, and more specifically to systems and methods for processing video data received from video cameras for automatic identification of items of outfit on a person.

### BACKGROUND

Currently, various video surveillance systems are widely used. It is difficult to imagine a place that would not have installed video cameras. After all, every store, shopping mall, enterprise, and even homes and parks use video surveillance systems to ensure overall safety and control.

In the context of this application, a video surveillance system refers to hardware and software that uses computer vision techniques for automated data collection based on the analysis of streaming video (video analysis). Such video systems are based on image processing algorithms, including algorithms for image recognition, segmentation, classification, and identification, allowing video analysis without direct human involvement. Modern video systems, among other things, make it possible to automatically analyze video data from cameras and compare this data with the data in the database.

Recently, the topic of recognition of clothing/safety gear on a person has been gaining momentum. For example, such recognition technologies can help in finding people based on video data, if it is known what kind of clothes the person is wearing. In addition, the recognition of clothes on a person can be useful for employees of clothing stores to quickly determine the style of the customer and offer them clothes to match their taste and style. Also, the recognition of items of safety gear can be used to monitor the wearing of protective clothing in various hazardous enterprises, or to ensure observance of the rules for wearing personal protective equipment (PPE).

From the background of the invention, we know a solution disclosed in U.S. Pat. No. 8,891,880 B2, G06K 9/34, pub. 18.11.2014, describing various devices and methods for retrieving clothing characteristics for searching for people. The method of searching for a person, as implemented by the processor, includes the following stages: searching for clothing feature parameters based on a clothing query text representing the type and color of a person's clothing; generating a clothing feature query based on clothing feature parameters; comparing the clothing feature query with clothing features extracted from the clothing feature storage, thereby obtaining a matching result; and generating a person search result based on the matching result.

The present solution mainly characterizes the technology of searching for people, with the search being based on the clothing characteristics of a person extracted from the input video. Thus, the known solution does not disclose in detail the basic stages of video data processing and specific technologies for identifying items of clothing and/or outfit.

From the background of the invention, we also know a solution disclosed in U.S. Pat. No. 8,379,920 B2, G06K 9/00, pub. 19.02.2013, which describes various systems and methods for recognizing clothing from video data. The system for recognizing the clothing by video includes: human detection and tracking means; means for evaluating texture properties based on a histogram of oriented gradient (HOG) in multiple spatial cells, a set of dense SIFT functions, and DCT responses, with gradient orientations in 8 directions (every 45 degrees) being calculated from color segmentation results; means for face matching and occlusion detection; and means for performing age and gender estimation, skin segmentation, and clothing segmentation for a linear support vector (SVM) device for subsequent recognition of the clothing worn by the person.

The solution known in the prior art differs substantially from the claimed solution and does not contain a detailed disclosure of the clothing recognition and identification stages.

As for the example of PPE identification, we know a solution disclosed in patent EP 2653772 B1, G06K 9/20, pub. 22.08.2018, which describes a system for determining the compliance of personal protective equipment, including memory and a processor; whereby the processor is configured to perform the following functions: determination of location of a person in the work area based on a signal from a location detection device; directing one or several image capture devices to a specific location of a person; receiving one or more images from an image capture device; detecting one or more PPE items in one or more images; detecting the location of one or more PPE items in one or more images; identification of the type of one or more PPE items; verification of PPE compliance with one or more PPE standards based on the location of one or more PPE items and the type of one or more PPE items; and sending a signal indicating the results of the compliance check. In the solution under consideration, identification of the type of one or more PPE items includes: identification of one or more tags associated with one or more PPE items.

The solution known from the prior art uses rather complicated image analysis and processing techniques to identify PPE and its position on a person. Thus, PPE tags are used for identification, which differs significantly from the claimed solution.

Thus, the main difference/advantage of their claimed solution from the solutions known in the prior art consists in the use of already available standard video surveillance and image processing tools, which together ensure quick and accurate identification of any items of equipment on a person based on video data.

The claimed solution is mainly aimed at simplifying, accelerating, and increasing the accuracy of the identification process, and, accordingly, at ensuring timely control over people in the surveillance area.

It should be noted that artificial neural networks are increasingly used in modern video systems for image segmentation, recognition, and identification. An artificial neural network (ANN) is a mathematical model, as well as its hardware and/or software embodiment, built on the principle of organization and functioning of biological neural networks (networks of nerve cells of living organisms). One of the main advantages of ANN is the possibility of their training, during which ANN can independently identify complex dependencies between input and output data.

It is due to the use of several ANNs for image processing, as well as due to the use of standard video surveillance and video data processing tools that the claimed solution is simpler to implement and more accurate compared to the solutions known in the prior art.

### BRIEF SUMMARY

This technical solution is aimed to eliminate the disadvantages of the previous background of the invention and develop the existing solutions.

The technical result of the claimed group of inventions is increased accuracy of identifying items of equipment on a person by using several artificial neural networks.

This technical result is achieved by the fact that the system for identifying outfit on a person includes the following: a memory configured to store a database that includes at least a selection of the outfit item images (OI), as well as information about the necessary OI in different areas of control; at least one image capture device configured to receive image data from the control area, where the person is; and at least one data processing device containing the following: video data acquisition module configured to receive video data from at least one image capture device in real time; image analysis module configured to analyze the video data to detect at least one person and define zones of control in the frame, whereupon the resulting image of the person and information about the control area is sent to the segmentation module; segmentation module configured to segment the received image of a person to individual control areas using artificial neural network (ANN); identification module configured to identify each of the OI on at least one of the resulting images of individual control areas with the use of one or more separate artificial neural networks; whereby the identification module further divides the identification results into at least three possible categories of the OI state, each having a vector of probability built as a result of the passing through one or more ANNs; an output module configured to output the identification results.

The specified technical result is also achieved by a method for identifying outfit on a person implemented by a computer system containing at least one data processing device and a memory storing a database, which includes at least a selection of outfit item images (OI), as well as information about the necessary OI in different control areas; whereby the method contains the stages at which the following operations are performed: video data is received from at least one image capture device in real time; whereby the image capture device receives video data from the control area where the person is; the received video data is analyzed in order to detect at least one person in the frame data about the control area; the obtained image of a person is segmented into separate images of control areas using an artificial neural network (ANN); each OI on at least one of the resulting images of individual control areas is identified using one or more separate artificial neural networks; whereby the identification results are further divided into at least three possible categories of the OI state, each having a vector of probability built as a result of the passing through one or more ANNs; the identification results are displayed.

In one specific version of the claimed solution, the OI state categories are at least: a correct OI state (1); at least one or more OI states differing from a correct OI state (2); noises not allowing for correct OI identification (3); whereby if there are two or more states differing from a correct OI state (2), then each such possible state will have a different probability value vector at the output from one or more ANNs.

In another specific version of the claimed solution, the output module displays as an identification result only the OI state category of the highest probability value; whereby, and if a category (2) has the highest probability value, the system is additionally configured to perform user-defined actions.

In another specific version of the claimed solution, if the OI contain of several constituent parts, multiple ANNs corresponding to the number of parts of that OI may be used to identify one OI.

In another specific version of the claimed solution, the control areas include at least the following: head, shoulders, forearms, hands, body, hips, shins, feet.

In another specific version of the claimed solution, the identification module is further configured to combine multiple control areas received from the segmentation module into a single area for subsequent identification of the OI on the resulting combined control area.

In another specific version of the claimed solution, the segmentation module is further configured to discard images of the people who are located at a distance greater than the maximum allowable distance preset by the user relative to the image capture device, as well as images of the people who are in undescriptive poses.

In another specific version of the claimed solution, the outfit items (OI) include but are not limited to the following: personal protective equipment (PPE), clothing items, costumes, work uniform items, military equipment items.

In another specific version of the claimed solution, the identification is performed according to the data obtained from the information of the required OI in the particular control area in which the person in question is located.

In addition to the above, this technical result is also achieved by a computer-readable data carrier containing instructions executable by a computer processor for carrying out methods of identification of the outfit on a person.

### BRIEF DESCRIPTION OF THE SEVERAL VIEWS OF THE DRAWINGS

FIG. 1 is a block diagram of a system for identifying outfit on a person.

FIG. 2 is a block diagram of the method for identifying outfit on a person.

### DETAILED DESCRIPTION

Exemplary embodiments of the claimed group of inventions will be described below. However, the claimed group of inventions is not limited only to these embodiments. It will be obvious for those skilled in the art that other embodiments may also fall within the scope of the claimed group of inventions described in the claims.

The claimed technical solution in its various versions can be embodied in the form of computer systems and methods implemented by various computer tools, as well as in the form of a computer-readable data carrier that stores instructions executed by the computer processor.

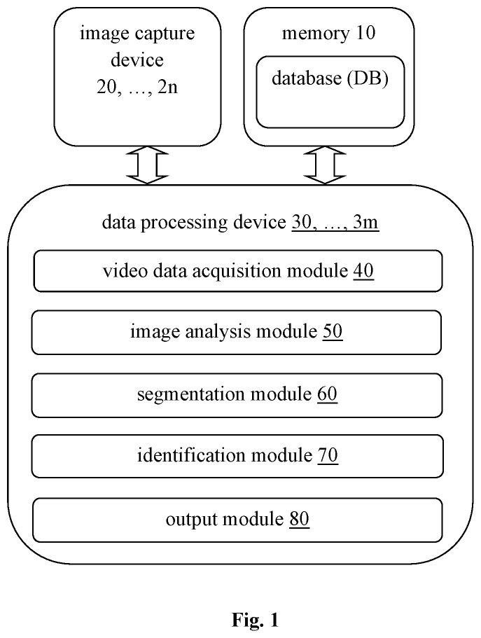

FIG. 1 shows a block diagram of a system for identifying outfit on a person. This system includes: a memory (10) configured to store a database (DB); at least one image capture device (20, . . . , 2n); and at least one data processing device (30, . . . , 3m) containing: a video data acquisition module (40), an image analysis module (50), a segmentation module (60), an identification module (70), and an output module (80).

In this context, computer systems may be any hardware- and software-based interconnected technical means.

In the context of this application, an image capture device means a video camera.

A data processing device may be a processor, a microprocessor, a graphics processor, a computer (electronic computer), a PLC (programmable logic controller), or an integrated circuit configured to execute certain commands (instructions, programs) for data processing.

Memory devices configured to store data may include, but is not limited to hard disk drives (HDD), flash memory, server, ROM (read-only memory), solid state drives (SSD), optical data storage devices, etc.

In the context of this application, the memory stores a database that includes at least a selection of images of the outfit items (OI), as well as information about the required OIs in the various control areas (if any).

Outfit is a set of clothing items used by a person for a specific purpose. Outfit items (OI) include but are not limited to the following: personal protective equipment (PPE), any clothing item (shirt, pants, sweatshirt, pants, tank top, shorts, coat, etc.), costumes (e.g., a clown costume or the costume of any character from a movie or cartoon), work uniform items (overalls, coveralls, vests), military equipment items (military uniform and related attributes).

Personal protective equipment (PPE) includes items designed to protect a person from various physical or chemical effects. PPE may include skin protection equipment (special clothing, shoes, insulating suits, vests, coveralls), respiratory protection equipment (gas masks, respirators, insulating breathing apparatus, set of additional cartridges), hand protection (gloves), head protection gear (helmet), face protection gear (mask, respirator), hearing organ protection gear (headphones, earmuffs), eye protection gear (goggles), various safety devices (safety ropes), and so on.

As for the selection of outfit item (OI) images, the claimed OI identification system is configured to automatically replenish the said selection of images of each OI and to train at least one artificial neural network to be used. Replenishment of the image selection and training of at least one ANN are continuous processes, since the set of OIs and their appearance may change over time. Thus, in the context of the claimed solution, training of each ANN is performed based on the OI database being replenished. Moreover, training of the ANN can be carried out either by a data processing device of the system or a cloud service, or any other computing device.

It should be noted that the described system may also include any other devices known in the give state of the art, for example, such as various kinds of sensors, input/output devices, display devices, etc.

An example of operation of the above-mentioned system for identification of outfit on a person will be described in detail below. All system operation stages described below are also applicable to the implementation of the claimed method for identifying outfit on a person, which will be discussed in more detail below.

Let us consider the principle of operation of this identification system. Let us assume that this system and the software corresponding to it are installed at an enterprise (plant or factory). Employees come to work in the morning and, according to their position, they put on the necessary items of outfit (OI), such as work clothes and PPE. Once the employee has put on the necessary items, they go to the control area. In the context of this application, a control area is defined as a room equipped with at least one video camera to identify OI on a person and to monitor, check, and control the actions of people. The control area may be, for example, a work room.

At least one image capture device of the system in question, in this case a video camera, is positioned in the room so as to continuously receive real-time video data from the control area in which a person or several persons are located. It should be noted that the described identification and video surveillance system may include several video cameras to receive more video data and increase the accuracy of the results processing. That is, several video cameras can be installed in each room that requires monitoring. Thus, the number of monitored rooms is also not limited. In addition, in some versions, when setting up a video camera for a particular control area, the system operator can set a specific OI to be monitored on a person in the control area in which the video camera is located.

Further, at least one data processing device, such as a computer graphics processor, performs the main work. The said data processing device includes separate software or hardware modules/units, each of which is configured to perform a specific task. In the described solution, as illustrated in FIG. 1, the data processing device includes the following modules: a video data acquisition module (40), an image analysis module (50), a segmentation module (60), an identification module (70), and an output module (80). The operation of each module will be described in detail below.

The video data acquisition module (40) continuously receives all video data from at least one or more real-time image capture devices. All received video data is then analyzed by the image analysis module (50) to identify/detect frames showing/characterizing at least one person and to detect the control area. The control area data can be determined by the image processor from the metadata sent by each image capture device to the data processing unit along with the video data. It should be noted that, when installing the system in a plant, all image capture devices should preferably be placed in the control areas to completely cover the entire premise (the fields of view of the cameras may slightly overlap, to get the complete picture). Thus, the image analysis module (50) can easily detect a person and get good one or more images from the video data. As for the video data analysis, depending on the settings preset by the user, the analysis is performed either continuously, or at a time interval set by the system user, or upon a signal from the user. After the system has detected a frame with a person and has received data about a specific control area in which the detected person is located, at least one received image/frame of the said person and the corresponding data about the control area are automatically sent to the segmentation module (60).

The segmentation module (60) is configured to segment the received person image into individual images of control areas. The said segmentation is performed using its artificial neural network. It should be noted that segmentation may be performed by color and/or shape and/or texture. The system user may specify any type of segmentation, or the segmentation may be performed sequentially by each of the listed methods to obtain the best results. In the context of this application, the said control areas are the anatomical parts of the human body, which include at least eight parts such as: head, shoulders, forearms, hands, body, hips, shins, feet.

In addition, in one version of the system, the segmentation module (60) is further configured to discard images of the people who are located at a distance greater than the maximum allowable distance preset by the system user relative to the image capture device. That is, when people in the frame are visually distinguishable, but are too far away to perform subsequent correct data processing. The segmentation module (60) is also configured to discard images of the people who are in undescriptive poses (e.g., when the person is sitting or bent over). This is necessary to reduce the number of false activations of the system, because, in the cases described above, there are often problems with correct identification of the OI.

After dividing the human image into individual images of its anatomical parts (8 control areas), these individual images are further sent to the identification module (70). The said module performs an identification of each outfit item on each of the received individual images of the control areas using its separate at least one or several classification artificial neural networks (ANNs). The identification is performed by comparing each recognized OI image with at least one OI image contained in the system database. Thus, the data about each OI in the database includes at least: name, main characteristics (such as size, shape, color palette), and a selection of reference images. In addition, each image in the selection of reference images of OI includes a descriptor characterizing a vector of numbers of this image.

It should be mentioned that in one of the versions of the system, the identification module (70) is further configured to combine multiple control areas received from the segmentation module (60) into a single area for subsequent identification of the OI on the resulting combined control area. For example, to identify pants on a person, the identification module automatically combines two “shin” and “hips” control areas to obtain an additional “leg” control area. Similarly, “shoulders”, “forearms”, and “body” are combined to identify a long-sleeved sweatshirt.

The identification principle is as follows: the artificial neural network (in this case, the classification ANN) receives a separate image of the control area (for example, the control area “head”) and then produces a vector of numbers—the image descriptor. Thus, as it was already indicated earlier, the system database stores a selection of the reference images of all possible OIs, including the descriptor corresponding to each OI image. The classification ANN uses these descriptors to compare the images. The ANN is trained so that the smaller the angle between these vectors of numbers in space, the greater the probability of matching images. As a metric for comparison, the cosine of the angle between the number vectors (vectors from the database and the resulting image vector of the control area) is used. Accordingly, the closer is cosine of angle between vectors to one, the higher the probability that OI is the same in the compared pair of images.

In contrast to our previously patented technical solution (see patent RU 2724785 B1), the identification module (70) of the claimed system is additionally configured to divide the obtained identification results into at least three possible categories of OI state, each having a different probability value vector built by passing through one or more classification ANNs. In the context of this application, said categories of OI states include at least the following: a correct OI state (1); at least one or more OI states differing from a correct OI state (2); and noises that do not allow a correct OI identification (3). Thus, using the identification module, we get a vector of probability values for each of the possible OI state categories. Moreover, if there are two or more states, which differ from the correct OI state (2), then each of such possible state will have its own vector of probability at the output of one or more classification ANNs.

As an example, let us consider a situation when all people must wear a helmet with a flashlight to comply with safety regulations at the plant. That is, if a person is wearing a helmet with a flashlight, this is the correct PE state (1). If the person is wearing a helmet without a flashlight (a) or no helmet at all (b), these two OI states are categorized as (2). If the image of the person's head is low-contrast or blurred, or too dark or light, the system cannot determine whether the image has an OI control area or not. In this case, the system will classify the identification result as noise (3). For example, let us assume that, as a result of the identification, the module determined that a person wears a helmet with a flashlight (that is category (1)) with a probability 0.6 (60%), a person wears a helmet without a flashlight (that is category (2)) with a probability 0.2 (20%), and a person has no helmet on (that is category (2)) with a probability 0.1 (10%), and the image considered by the system is noise (that is category (3)) with a probability 0.1 (10%). Based on the obtained probability values, it is logical to assume that the person in the image is wearing a helmet with a flashlight, because the obtained probability is the highest. And since the state category corresponds to the OI correct state category (1), the system does not take any further action with respect to the person in question.

It should be noted that the vector of probability output by the system as an identification result is the output of the classification ANN. Topology of the network can vary, as can the number of OI state categories that the system tries to identify. Output of the ANN is generally understood as direct passing of the ANN and is represented as a vector (or set of vectors) of probabilities of belonging to the categories. It is by the output of the ANN that the system identifies various violations of wearing OI. For example, let us suppose that the identification module has divided the identification output into three OI state categories—(1) masked person, (2) unmasked person, and (3) noise. So, the output would be “0:0.1 1:0.7 2:0.2”. That is, based on the data obtained, it appears that the person is not wearing a mask, which is a violation.

For the case when OI consists of several components (for example, helmet+flashlight=helmet with flashlight), several ANNs corresponding to the number of components of this OI (for this example two ANNs) can be used for identification of such complex/combined OI in specific system versions. Thus, in the claimed solution, several separate ANNs are used to identify a single OI. This may also be relevant and useful when several state categories of a single OI are very similar in features. For example, a person wearing a protective cover all refers to a category (1), and a person wearing a protective but not buttoned up coverall refers to a category (2). In this case, it is easier to train several separate ANNs (i.e., a different ANN for each category) to achieve the best identification results. In addition, it is also logical to use separate ANNs to identify individual (simple) OIs such as helmet and flashlight.

In one version of the system, the identification of OI is performed according to the data obtained from the information of the required OI in the particular control area in which the person in question is located. In this version, the identification module (70) tries to identify OI only in the control areas where, according to the particular control area, OI should be present, while not wasting system computing resources on recognizing OIs in other control areas, since there are no requirements for wearing OIs on other parts of the body for the control area in question. For example, considering the current situation, a mask/respirator and gloves must be worn in almost any store or shopping mall during a pandemic. In this case, the system user presets the system so that only PPE such as gloves, mask, and respirator will be identified in the sales area (control area). In this case identification of PPE will be performed only on two control areas: “head” and “hands”. These settings can be set either in each individual camera or via the data processor.

After identification of all OIs, the identification results are sent to the output module (80), which is designed to output the obtained identification results. In some versions of the system, the output module (80) outputs only the state category of the OI corresponding to the highest probability value as an identification result for each OI. If the highest probability value falls at the state category noise (3), then this result is not used by the system in any way. That is, it is simply ignored. Thanks to this feature, the system easily eliminates noises that could otherwise lead to false activations of the system. If the maximum/maximum value of probability falls at the state category (1), i.e., when OI is in correct state, then no further action is taken by the system. But if category (2) has the highest value of probability, i.e., when OI state is not correct, then the system is additionally configured to perform actions preset by the system user. For example, if a person must be wearing a mask, and the system has determined that the person is not wearing a mask, then the output module (80) can automatically send an alarm to the system operator or security officer, with data about the place and time of the violation, as well as personal data of the violator.

It should be noted that the identification results are in no way displayed on the screen of the system operator, that is, they are simply stored by the system in the database for further control over the system operation or for drawing up various reports.

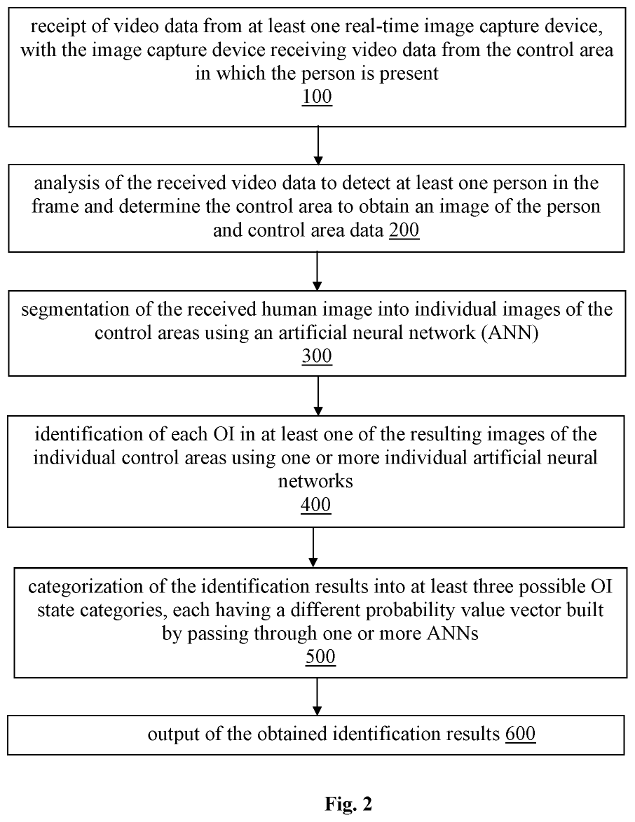

An example of a specific implementation of the method for identifying outfit on a person will be described below. FIG. 2 shows a block diagram of one of the embodiments of the method for identifying outfit on a person.

The said method is performed by a computer system described above, containing at least one data processing device and a memory storing a database, which includes at least a selection of images of outfit items (OI), as well as information about OIs required in the various control areas.

The claimed method in a basic embodiment includes the steps at which the following operations are performed:

(100) video data is received from at least one real-time image capture device, with the image capture device receiving video data from the control area in which the person is present;

(200) the received video data is analyzed to detect at least one person in the frame and determine the control area to obtain an image of the person and control area data;

(300) the received human image is segmented into individual images of the control areas using an artificial neural network (ANN);

(400) each OI is identified in at least one of the resulting images of the individual control areas using one or more individual artificial neural networks,

(500) wherein the identification results are further categorized into at least three possible OI state categories, each having a different probability value vector built as a result of passing through one or more ANNs; and

(600) the obtained identification results are output.

It should be noted once again that this method can be implemented by means of the system described earlier and therefore can be expanded and refined by all specific embodiment options described above for implementation of the system for identifying the outfit items on a person.

In addition, embodiments of this group of inventions can be implemented using software, hardware, software logic, or a combination of them. In this implementation example, program logic, software, or a set of instructions are stored on one or more of the various conventional computer-readable data carriers.

In the context of this description, a “computer-readable data carrier” may be any environment or medium that can contain, store, transmit, distribute, or transport the instructions (commands) for their application (execution) by a computer device, such as a personal computer. Thus, a data carrier may be an energy-dependent or energy-independent machine-readable data carrier.

If necessary, at least some part of the various operations presented in the description of this solution can be performed in an order differing from the described one and/or simultaneously with each other.

Although the technical solution has been described in detail to illustrate the most currently required and preferred embodiments, the invention is not limited to the embodiments disclosed and, moreover, is intended to modify and combine various other features of the embodiments described.

For example, this disclosure implies that, to the possible extent, one or more features of any embodiment option may be combined with one or more other features of any other embodiment option.

1. A system for identifying outfit on a person, comprising:
memory configured to store a database that comprises at least a selection of images of outfit items, as well as information about the required outfit items in various control areas;
at least one image capture device configured to receive video data from the control area in which the person is located; and
at least one data processing device comprising:
a video acquisition module configured to receive video data from at least one real-time image capture device;
an image analysis module configured to analyze video data in order to detect at least one person in the frame and determine the control area, whereupon the resulting image of the person and data about the control area are sent to the segmentation module;
a segmentation module configured to segment the received human image into individual images of the control areas using an artificial neural network (ANN);
an identification module configured to identify each outfit items on at least one of the resulting images of individual control areas using one or more separate artificial neural networks; whereby the identification module additionally divides the identification results into at least three possible categories of the outfit items state, each having a different probability value vector built as the result of passing through one or more ANNs;
an output module configured to output the obtained identification results.

2. The system of claim 1,
wherein the categories of outfit items comprise:
a correct outfit items state (1);
at least one or more outfit items states differing from a correct outfit items state (2); and
noises that do not allow a correct outfit items identification (3);
wherein, if there are two or more states, which differ from the correct outfit items state (2), then each of such possible state will have its own vector of probability at the output of one or more classification ANNs.

3. The system of claim 2,
wherein the output module displays as an identification result only the outfit items state category of the highest probability value;
wherein, and if a category (2) has the highest probability value, the system is additionally configured to perform user-defined actions.

4. The system according to claim 2, wherein if the outfit items contain of several components, then several ANNs can be used to identify one outfit items, corresponding to the number of components of this outfit items.

5. The system according to claim 1, wherein the areas of control include at least the following: head, shoulders, forearms, hands, body, hips, shins, feet.

6. The system according to claim 5, wherein the identification module is further configured to combine multiple control areas received from the segmentation module into a single area for subsequent identification of the outfit items on the resulting combined control area.

7. The system according to claim 5, wherein the segmentation module is further configured to discard images of the people who are located at a distance greater than the maximum allowable distance preset by the user relative to the image capture device, as well as images of the people who are in undescriptive poses.

8. The system according to claim 1, wherein the outfit items include at least, but are not limited to: personal protective equipment (PPE), clothing items, costumes, work uniforms, military equipment items.

9. The system according to claim 1, wherein identification is performed in accordance with the data obtained from the information about the necessary outfit items in the control area in which the person in question is located.

10. The method for identifying outfit on a person, implemented by a computer system containing at least one data processing device and a memory storing a database, which includes at least a selection of images of outfit items, as well as information about outfit items required in different control areas; whereby the method contains the stages at which the following operations are performed:
video data is received from at least one real-time image capture device, with the image capture device receiving video data from the control area in which the person is present;
the received video data is analyzed to detect at least one person in the frame and determine the control area to obtain an image of the person and control area data;
the received human image is segmented into individual images of the control areas using an artificial neural network (ANN);
each outfit items is identified in at least one of the resulting images of individual control areas using one or more separate artificial neural networks; whereby the identification module additionally divides the identification results into at least three possible categories of the outfit items state, each having a different probability value vector built as the result of passing through one or more ANNs;
the obtained identification results are output.

11. The method according to claim 10, wherein the categories of outfit items states include at least the following: a correct outfit items state (1); at least one or more outfit items states differing from a correct outfit items state (2); and noises that do not allow a correct outfit items identification (3); whereby, if there are two or more states, which differ from the correct outfit items state (2), then each of such possible state will have its own vector of probability at the output of one or more classification ANNs.

12. The method according to claim 11, wherein the output module displays as an identification result only the outfit items state category of the highest probability value; whereby, and if a category (2) has the highest probability value, the system is additionally configured to perform user-defined actions.

13. The method according to claim 11, wherein if the outfit items contain of several components, then several ANNs can be used to identify one outfit items, corresponding to the number of components of this outfit items.

14. The method according to claim 10, in which the areas of control include at least the following: head, shoulders, forearms, hands, body, hips, shins, feet.

15. The method according to claim 14, wherein the identification module is further configured to combine multiple control areas received from the segmentation module into a single area for subsequent identification of the outfit items on the resulting combined control area.

16. The method according to claim 14, wherein the segmentation module is further configured to discard images of the people who are located at a distance greater than the maximum allowable distance preset by the user relative to the image capture device, as well as images of the people who are in undescriptive poses.

17. The method according to claim 10, wherein the outfit items include at least, but are not limited to: personal protective equipment (PPE), clothing items, costumes, work uniforms, military equipment items.

18. The method according to claim 10, wherein identification is performed in accordance with the data obtained from the information about the necessary outfit items in the control area in which the person in question is located.

19. A computer-readable data carrier containing instructions executed by the computer processor for implementing methods for identifying outfit on a person according to claim 10.
